(19) United States
(12) Patent Application Publication
(10) Pub. No.: US 2013/0020988 A1
(43) Pub. Date: Jan. 24, 2013

(54) Multi-Frequency Wireless Systems and Methods

(71) Applicants: Dukhyun Kim, Marietta, GA (US); Yun Ho Lee, Alpharetta, GA (US); Youngsik Hur, Alpharetta, GA (US)

(72) Inventors: Dukhyun Kim, Marietta, GA (US); Yun Ho Lee, Alpharetta, GA (US); Youngsik Hur, Alpharetta, GA (US)

(73) Assignee: Samsung Electro-Mechanics Company, Ltd., Gyunggi-Do (KR)

(21) Appl. No.: 13/550,684

(22) Filed: Jul. 17, 2012

Related U.S. Application Data
(60) Provisional application No. 61/510,282, filed on Jul. 21, 2011.

(51) Int. Cl. H02J 7/00

(52) U.S. Cl. 320/108

(57) ABSTRACT

Systems and methods pertaining to multi-frequency wireless power transfer are disclosed. In one exemplary implementation, a wireless charger is used to generate and transmit two wireless power charges at two different frequencies, using a frequency division multiplexed (FDM) format. A wireless sly chargeable device that is inductively coupled to the wireless charger receives the two wireless power charges in the FDM format and uses the two charges to charge one or more chargeable batteries contained in the wirelessly chargeable device.

### RELATED APPLICATION

The present application claims priority to U.S. Provisional Patent Application No. 61/510,282, filed Jul. 21, 2011, and entitled “FREQUENCY DIVISION MULTIPLEXED (FDM) WIRELESS POWER PROCESSING,” which is hereby incorporated in its entirety as if fully set forth herein.

### DESCRIPTION OF THE RELATED ART

A rechargeable battery contained inside a device may be charged in at least two different ways depending on the circuitry provided in the device.

In the first approach, the rechargeable battery may be charged by connecting a power cable to the device and providing a charging current derived from a fixed power source such as an electrical wall outlet. This approach provides several advantages such as for example, a predictable charging environment in which the charging voltage level and current level can be specifically selected to be compatible to the device, and whereby the device can be charged to a known level within a predictable period of time.

However, this first approach suffers from some handicaps as well. As one example of a handicap, it can be appreciated that in some situations it may be inconvenient to charge multiple devices at the same time because of an insufficient number of electrical wall outlets available for use.

In a further example of a handicap, it can be understood that, in existing practice, various devices typically require different charging voltages and different charging currents. This problem has been often addressed by using customized charging devices such as battery eliminators and voltage converters. However, as can be appreciated using such customized charging device leads to various cost penalties associated with design, manufacture, and distribution.

In an alternative approach to charging a rechargeable battery, a device containing a rechargeable battery may be charged wirelessly by placing the device in proximity to a wireless-charging element. Charge transfer from the wireless-charging element to the rechargeable battery may be implemented in several different ways, for example, by using an inductive charge coupling mechanism or a capacitive charge coupling mechanism. The wireless charging approach provides several benefits such as for example, allowing multiple devices to be charged simultaneously. In one case, this may be carried out by placing the multiple devices upon a charging mat.

However, the wireless approach also suffers from certain handicaps. For example, it may be difficult to provide multiple wireless charges simultaneously to two or more devices. Even when feasible, carrying out simultaneous charging of multiple devices necessitates that each of the multiple devices be compatible with the power charging level provided by the charging element. In other words, power levels provided by a wireless power charger to the multiple devices cannot be typically customized in accordance with the power levels desired in each of the individual devices.

### SUMMARY

According to a first aspect of the disclosure, a system includes a wireless charger. The wireless charger includes a power management system and two wireless power charge transmitters. A first amongst the two wireless power charge transmitters is used for providing a first wireless power charge that may be used for charging a first chargeable battery. The first wireless power charge transmitter generates the first wireless power charge at a first frequency and at a first power level, the first power level defined by the power management system. The second amongst the two wireless power charge transmitters is used for providing a second wireless power charge that may be used for charging a second chargeable battery. The second wireless power charge transmitter generates the second wireless power charge at a second frequency and at a second power level, the second power level also defined by the power management system.

According to a second aspect of the disclosure, a system includes a wireless chargeable device. The wireless chargeable device includes two wireless power charge receivers. The first wireless power charge receiver is used for receiving a first wireless power charge at a first frequency, and for coupling the first wireless power charge to a first chargeable battery. The second wireless power charge receiver is used for receiving the second wireless power charge at a second frequency, and for coupling the second wireless power charge to a second chargeable battery.

According to a third aspect of the disclosure, a method includes: transmitting a first wireless power charge at a first frequency; receiving the first wireless power charge in a first wireless power charge receiver; using the received first wireless power charge to charge a first chargeable battery in the first wireless power charge receiver; transmitting a second wireless power charge at a second frequency; receiving the second wireless power charge in a second wireless power charge receiver; and using the received second wireless power charge to charge a second chargeable battery in the second wireless power charge receiver.

Further aspects of the disclosure are shown in the specification, drawings and claims below.

### BRIEF DESCRIPTION OF THE DRAWINGS

Many aspects of the invention can be better understood with reference to the following drawings. The components in the drawings are not necessarily to scale. Instead, emphasis is placed upon clearly illustrating the principles of the invention. Moreover, in the drawings, like reference numerals designate corresponding parts, or descriptively similar parts, throughout the several views and embodiments.

FIG. 1 shows a first embodiment of a multi-frequency wireless power transfer system that includes a wireless charger providing power to a wirelessly chargeable device in accordance with invention.

FIG. 2 shows a second embodiment of a multi-frequency wireless power transfer system that includes a wireless charger providing power to two wirelessly chargeable devices in accordance with invention.

FIG. 3 shows a third embodiment of a multi-frequency wireless power transfer system that incorporates an FDM format for providing power to a wireless sly chargeable device in accordance with invention.

FIG. 4 shows a fourth embodiment of a multi-frequency wireless power transfer system that incorporates an FDM format for providing power to two wireless sly chargeable devices in accordance with invention.

FIG. 5 shows a fifth embodiment of a multi-frequency wireless power transfer system that incorporates an FDM format for providing power to a first wirelessly chargeable device and a non-FDM format for providing power to a second wireless sly chargeable device, in accordance with invention.

FIG. 6 shows a flowchart of a method of incorporating an FDM format for transmitting wireless power charges in accordance with the invention.

FIG. 7 shows a flowchart of a method of receiving and using wireless power charges in accordance with the invention.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein. For example, it will be understood that terminology such as power, voltage, current, power transfer, chargeable, rechargeable, charging, and coupling are used herein as a matter of convenience for description purposes and should not be interpreted in a limiting manner. The phrase “power transfer” may be interchangeably referred to herein as “wireless charging.” Also, the term “chargeable” may be used interchangeably with the term “rechargeable” as a matter of convenience. One of ordinary skill in the art will recognize that the phrase “charging a battery” may be alternatively referred to as “recharging the battery.” Hence, the various phrases and terms used herein should be interpreted solely to understand the invention rather than to limit the scope of the concept.

It must also be understood that the word “example” as used herein (in whatever context) is intended to be non-exclusionary and non-limiting in nature. Specifically, the word “exemplary” indicates one among several examples, and it must be understood that no special emphasis is intended or suggested for that particular example. A person of ordinary skill in the art will understand the principles described herein and recognize that these principles can be applied to a wide variety of applications using a wide variety of physical elements.

The various embodiments generally describe systems and methods related to wireless power transfer. In particular, described herein are some systems and methods pertaining to wireless power transfer from a charger to one or more chargeable devices using multiple frequencies.

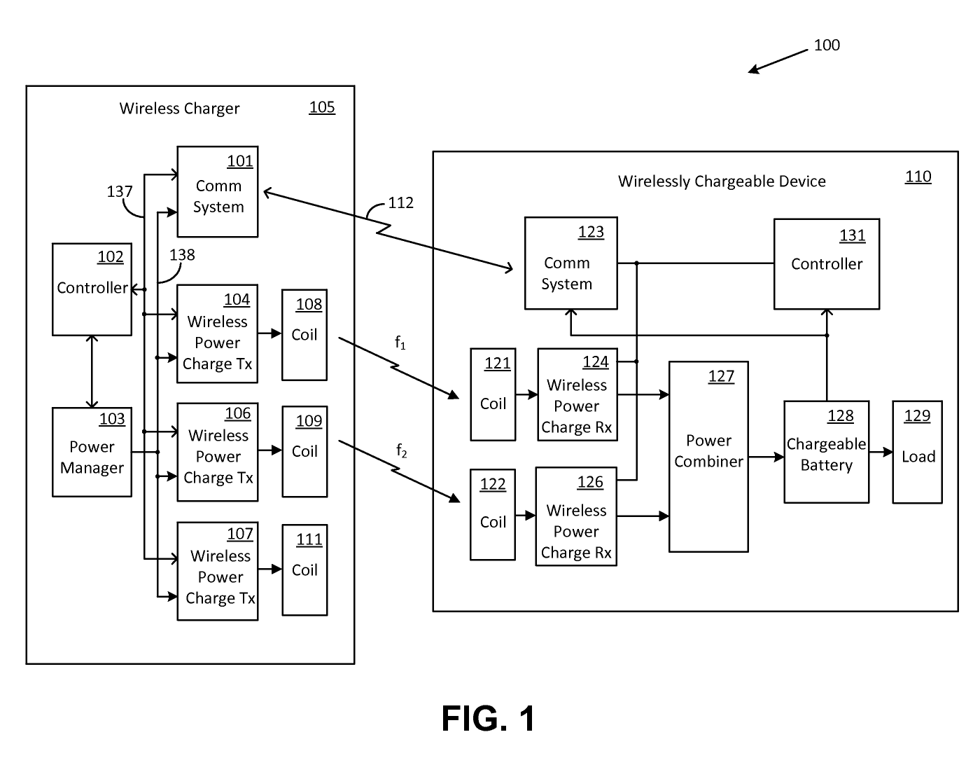

Attention is first drawn to FIG. 1, which shows a first exemplary embodiment of a multi-frequency wireless power transfer system 100 in accordance with invention. Wireless power transfer system 100 includes a wireless charger 105 that is used to coordinate with at least one wirelessly chargeable device 110 and to provide power for charging one or more rechargeable batteries, such as chargeable battery 128 contained in wirelessly chargeable device 110.

While the exemplary embodiment shown in FIG. 1 indicates wireless charger 105 as being used to charge a single wireless sly chargeable device 110, in other embodiments, wireless charger 105 may be used to charge multiple wirelessly chargeable devices. The various wireless sly chargeable devices may be similar to one another or may be different from one another. These aspects will be addressed below in further detail. It should be noted that in several instances, the description below refers to wirelessly chargeable device 110. However, it will be understood that this has been done solely for purposes of convenience, and the description may be equally applicable to the other similar wirelessly chargeable devices as well.

Wireless charger 105 includes a wireless communication system 101, a controller 102, a power manager 103 and multiple wireless power charge transmitters. Controller 102 is communicatively coupled via a communication bus 137 to wireless communication system 101 and to each of the wireless power charge transmitters. Power manager 103, which may be powered from an AC mains source and/or may contain batteries, is coupled via a power bus 138 to controller 102, wireless communication system 101 and each of the wireless power charge transmitters. In certain embodiments, power manager 103 includes processor circuitry that may be used to communicate and/or control the various elements that are coupled to power manager 103. In certain other embodiments, power manager 103 may provide power to one or more of the various elements that are coupled to power manager 103, for example, power used to generate wireless power charges in the wireless power charge transmitters.

Wirelessly chargeable device 110 includes a communication system 123, a controller 131, a chargeable battery 128, a coil 121 coupled to a first wireless power charge receiver 124, a coil 122 coupled to a second wireless power charge receiver 126, and a load 129. Controller 131 is communicatively coupled to communication system 116, first wireless power charge receiver 124, and second wireless power charge receiver 126 for carrying out control and communication functionality. Coil 121 receives power that is transmitted from wireless power charge transmitter 108 at a first frequency f₁ via inductive coupling with coil 108, and transfers this received power into first wireless power charge receiver 124. First wireless power charge receiver 124 includes one or more tuned circuits (not shown) that are tuned to frequency f₁ in conjunction with coil 121, and optimized to retrieve the power received in coil 121. The retrieved power is provided by first wireless power charge receiver 124 to power combiner 127.

Similarly, coil 122 receives power that is transmitted from wireless power charge transmitter 106 at a second frequency f₂ via coil 109. The second frequency f₂ is selected with reference to frequency f₁ so as to accommodate providing of two wireless power charges that do not interfere with each other. Coil 109 inductively couples with coil 122 located in wirelessly chargeable device 110, to transfer the wireless charge at frequency f₂ from wireless charger 105 to wireless sly chargeable device 110. Coil 122 couples the received power charge into second wireless power charge receiver 126. Second wireless power charge receiver 126 includes one or more tuned circuits (not shown) that are tuned to f₂ in conjunction with coil 122, and optimally retrieve the power received in coil 122. The retrieved power at frequency f₂ is provided to power combiner 127 where it is combined with the retrieved power provided at frequency f₁ by first wireless power charge receiver 124.

The combined power is then provided to chargeable battery 128 for charging purposes. Chargeable battery 128, in turn provides power to load 129 when so desired.

In an alternative embodiment, power combiner 127 is omitted and the two power charges provided by wireless power charge receives 124 and 126 are used for charging two separate chargeable batteries.

It will be understood that load 129 is a symbolic representation of any circuitry that draws power from chargeable battery 128. In a first embodiment, load 129 may be controllably, or manually, disconnected from chargeable battery 128, for example when chargeable battery 128 is being charged. As one example of this first embodiment, load 129 may be a cordless drill that is manually detachable from a receiver module (i.e. wirelessly chargeable device 110).

In a second embodiment, load 129 remains connected to chargeable battery 128 all the time. As one example of this second embodiment, load 129 may be the various parts (circuitry, speaker, display, etc) of a cellular phone, with rechargeable battery 128 located inside the cellular phone enclosure. As can be understood, in this embodiment, chargeable battery 128 is normally not removed from the cellular phone enclosure for purposes of charging.

In a third embodiment, load 129 is an energy storage element (instead of a battery) that may incorporate various energy storage components such as, for example, capacitors and inductors. The energy stored in the energy storage element may be subsequently used to power various elements such as controller 131 and wireless communication system 123.

Operational aspects of wireless power transfer system 100 will now be explained. Communications system 101, which may be referred to herein as master wireless communication system 101, wirelessly communicates with communication system 123, which may be referred to herein as a slave wireless communication system 123. As shown, master wireless communication system 101 communicates with wireless slave communication system 123 via communication link 112, using various communication protocols.

In one exemplary embodiment, near field communications (NFC) techniques are used. NFC techniques are particularly advantageous for implementing a mode of operation referred to herein as a discovery mode of operation. During the discovery mode of operation, master wireless communications system 101 detects the presence of one or more wireless sly chargeable devices that are located in the proximity of wireless charger 105.

Upon discovering a wirelessly chargeable device, master wireless communication system 101 establishes communication with slave wireless communication system 123. The communication protocol used for this purpose is selected to accommodate multiple, and in some cases simultaneous, communications interaction between master wireless communication system 101 and multiple slave wireless communication systems.

Once communication is established, a tracking mode of operation may be employed optionally whereby master wireless communication system 101 continuously or intermittently ascertains the presence of one or more wirelessly chargeable devices.

The discovery mode and/or the tracking mode of operation may be followed by a wireless power transfer mode of operation whereby wireless charger 105 provides power for charging chargeable battery 128. This process is carried out by transmitting power from individual wireless power charge transmitters located in wireless charger 105 to corresponding wireless power charge receivers located in wirelessly chargeable device 110.

Specifically, wireless charger 105 transfers power from wireless power charge transmitter 104, at a frequency f₁, into wireless power charge receiver 124 via coils 108 and 121, which operate as coupling coils for wirelessly transferring power from wireless charger 105 to wirelessly chargeable device 110. Wireless charger 105 may also transfer power from wireless power charge transmitter 106 at a frequency f₂, into wireless power charge receiver 126 via coils 109 and 122.

The amplitudes of one or both of the power charges transmitted by wireless charger 105 may be varied based on feedback obtained from one or more wireless sly chargeable devices, such as wireless sly chargeable device 110. This feedback may be obtained via communications between wireless communication systems 123 and 101 that are suitably conveyed to power manager 103, which then communicates with one or both of wireless power charge transmitters 104 and 106 in order to vary the amount of power transmitted out of the wireless power charge transmitters 104 and/or 106.

In the exemplary embodiment shown in FIG. 1, two wireless power charge transmitters 106 and 107 transfer two power charges at two discrete frequencies f₁ and f₂, that are used in wirelessly chargeable device 110 in a combination arrangement so as to provide a larger power charge to chargeable battery 128 than would be provided by a single wireless power charge. In contrast to this combination charging arrangement carried out in wirelessly chargeable device 110 (which may be, for example, a laptop computer with a heavy-duty battery), another exemplary wirelessly chargeable device (a cellular phone, for example) may use only one of the two power charges because the chargeable battery in this other wireless sly chargeable device may not require as large a power charge.

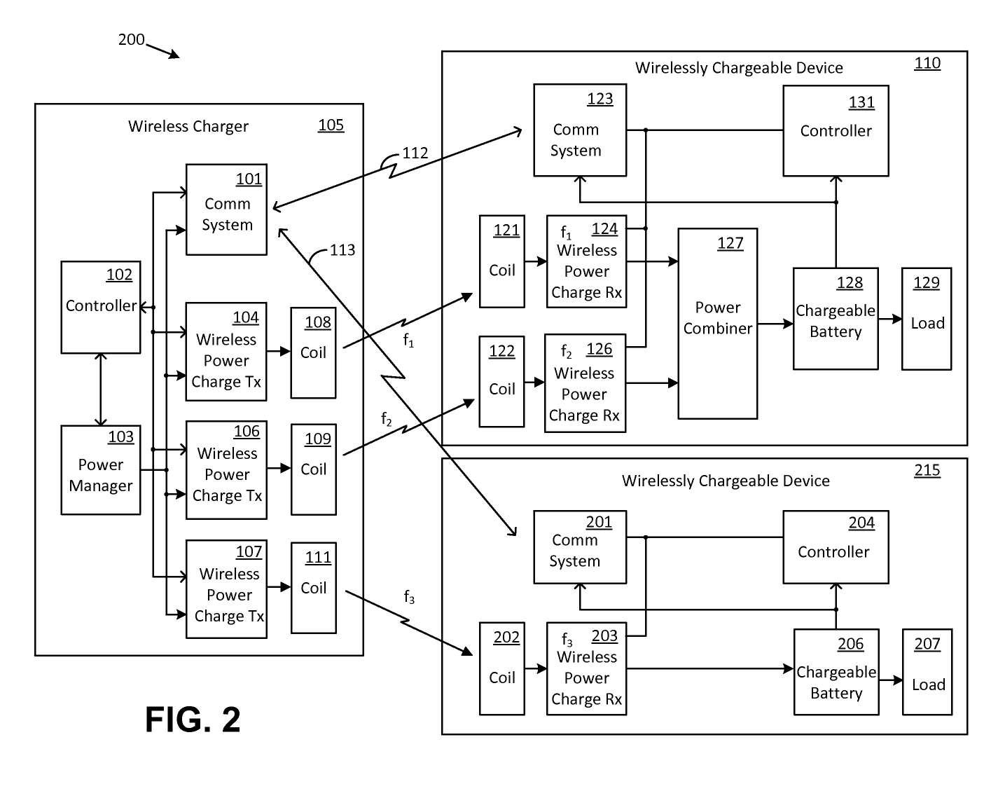

To illustrate this aspect in further detail, attention is now drawn to FIG. 2, wherein the two wireless power charge transmitters 104 and 106 transfer two power charges at two discrete frequencies f₁ and f₂, which are used in wireless sly chargeable device 110 in a combination arrangement. However, additionally, a third wireless power charge transmitter 107 in wireless charger 105 is configured to wireless sly transfer power from wireless power charge transmitter 107, at a third frequency f₃, into a second wirelessly chargeable device 215, specifically into wireless power charge receiver 203 via coils 111 and 202.

As explained above, wireless sly chargeable device 110 may be a laptop computer housing a heavy-duty chargeable battery 128, while wirelessly chargeable device 110 may be a cellular phone containing a smaller capacity rechargeable battery 206.

Furthermore, the amplitude of the power charge provided at the f₃ frequency may be varied based on feedback obtained by wireless charger 105 from wirelessly chargeable device 215. This feedback may be obtained via communications between wireless communication systems 201 and 101 that are suitably conveyed by communication system 101 to power manager 103, which then communicates with power charge transmitter 107 in order to increase or decrease the amount of power transmitted out of the wireless power charge transmitter 107.

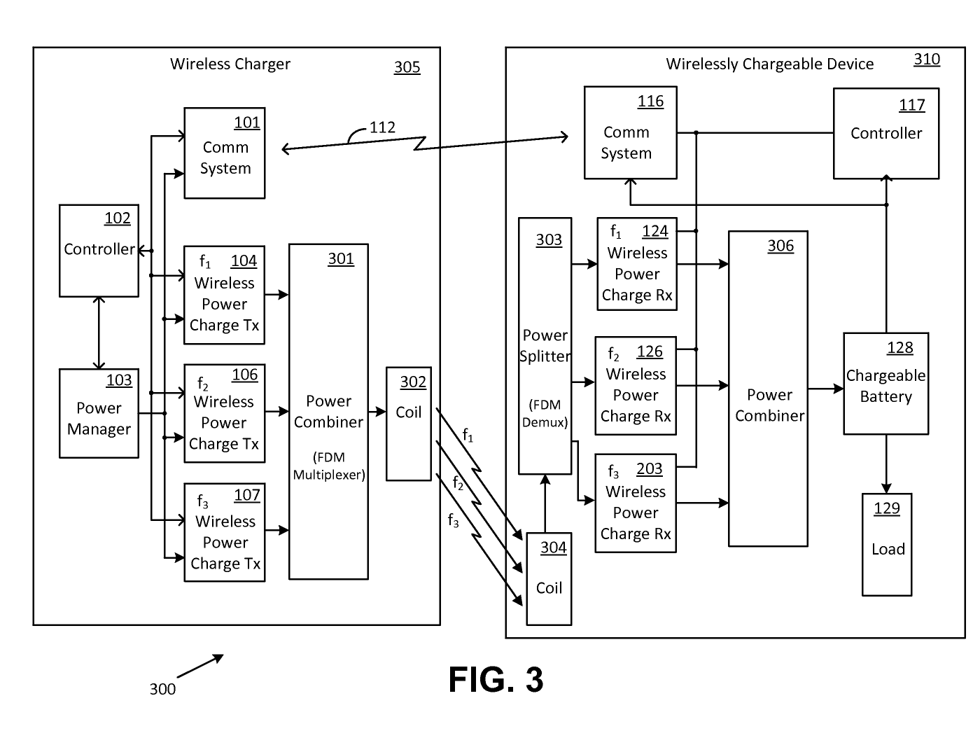

In contrast to the exemplary embodiment shown in FIG. 2 (where wireless charger 105 wirelessly transmits three charges at three discrete frequencies f₁, f₂, and f₃), in the exemplary embodiment shown in FIG. 3, multi-frequency wireless power transfer system 300 includes a wireless charger 305 that uses a frequency division multiplexing (FDM) format for wirelessly transmitting three charges at three frequencies f₁, f₂, and f₃.

In this embodiment, wireless charger 305, includes several elements that were described above with reference to FIGS. 1 and 2, such as wireless communication system 101, controller 102, power manager 103 and wireless power charge transmitters 104, 106 and 107. However, in contrast to the previously described embodiments, in this embodiment, only one coil 302 is used, and an additional element in the form of a power combiner 301 is introduced.

Power combiner 301 may be alternatively referred to herein as an FDM multiplexer in view of a multiplexing action performed by this element. To elaborate upon this multiplexing action - power combiner 301 accepts two or more power charges (in this case, three charges generated by wireless power charge transmitters 104, 106 and 107, at frequencies f₁, f₂ and f₃) and multiplexes these charges into one signal that is provided to a single coil 302.

Power combiner 301 may be implemented in various ways. For example, in a first implementation, power combiner 301 incorporates only passive components such as inductors and capacitors to provide functionalities such as impedance matching, selective signal attenuation on one or more of the three power charges, frequency-selective signal propagation (for example, filtering).

In another implementation, power combiner 301 incorporates passive as well as active components to condition one or more of the three power charges. The active components may be used to provide functionalities such as broad-band amplification, frequency-selective amplification, signal pre-emphasis, and frequency-selective propagation. These functionalities may be used, for example, to boost a first power charge of a first frequency, while attenuating a second power charge at a second frequency, or carrying out a pre-emphasizing action upon one or all of three power charges, thereby tailoring the FDM power charge to compensate for certain parameters, such as, for example, a non-linear frequency transfer characteristic of coil 302, or a frequency-dependent propagation characteristic of the coupling medium between coil 302 and coil 304.

Coil 302 is preferably selected to provide a broadband frequency characteristic selected for wirelessly propagating all three frequencies f₁, f₂ and f₃ out of wireless charger 305 in a balanced manner, thereby eliminating the three separate coils of the embodiments shown in FIGS. 1 and 2.

Coil 304, in wirelessly chargeable device 310, is similarly selected to provide a broadband frequency characteristic selected for wirelessly receiving the wireless FDM power charge (three frequencies f₁, f₂ and f₃) transmitted by wireless charger 305. Coil 304 couples the received FDM power charge into power splitter 303.

In one embodiment, power splitter 303,which may be alternatively referred to herein as an FDM demultiplexer, splits (demultiplexes) the FDM power charge received from coil 304 into the constituent power charges at the three frequencies f₁, f₂ and f₃.

Power splitter 303 may incorporate only passive components such as inductors and capacitors to provide functionalities such as impedance matching, selective signal attenuation on one or more of the three power charges, frequency-selective signal propagation (for example, filtering).

On the other hand, in certain implementations, power splitter 303 may incorporate passive as well as active components to operate upon one or more of the three power charges. The active components may be used to provide functionalities such as broad-band amplification, frequency-selective amplification, and frequency-selective amplitude modification. These functionalities may be used, for example, to boost a first power charge of a first frequency, while attenuating a second power charge at a second frequency, thereby tailoring the three constituent power charges to compensate for certain parameters, such as, for example, a non-linear frequency transfer characteristic of coil 304, or a frequency-dependent propagation characteristic of the coupling medium between coil 304 and coil 302 (in wireless charger 305).

It may be pertinent to point out that impedance matching plays a significant role in optimally receiving the FDM power charge in coil 304 at each of the three frequencies, and in optimally coupling the received power charge from coil 304 into power splitter 303.

The three power charges at frequencies f₁, f₂ and f₃ from power splitter 303 are coupled into a power combiner 306 that combines the three power charges and provides the combined charge to chargeable battery 128.

In an alternative implementation, power combiner 306 is omitted and the three power charges are provided to three separate batteries.

Furthermore, in contrast to the arrangement described above, where power splitter 303 splits the FDM power charge received from coil 304 into the constituent power charges at the three frequencies f₁, f₂ and f₃, in an alternative arrangement, power splitter 303 splits the FDM power charge received from coil 304 into three FDM power charges (each containing all three frequencies f₁, f₂ and f₃) and each of these three FDM power charges are then converted to power charges at discrete frequencies f₁, f₂ and f₃ by three wireless power charge receivers 124, 126 and 203. As can be understood, for this arrangement, the three wireless power charge receivers 124, 126 and 203 may include frequency selective circuitry such as frequency filters.

The choice between the two arrangements may be influenced, at least in part, by the impedance matching aspect described above, which determines the effectiveness of retrieving, in wirelessly chargeable device 310, the FDM power charge transmitted by wireless charger 305.

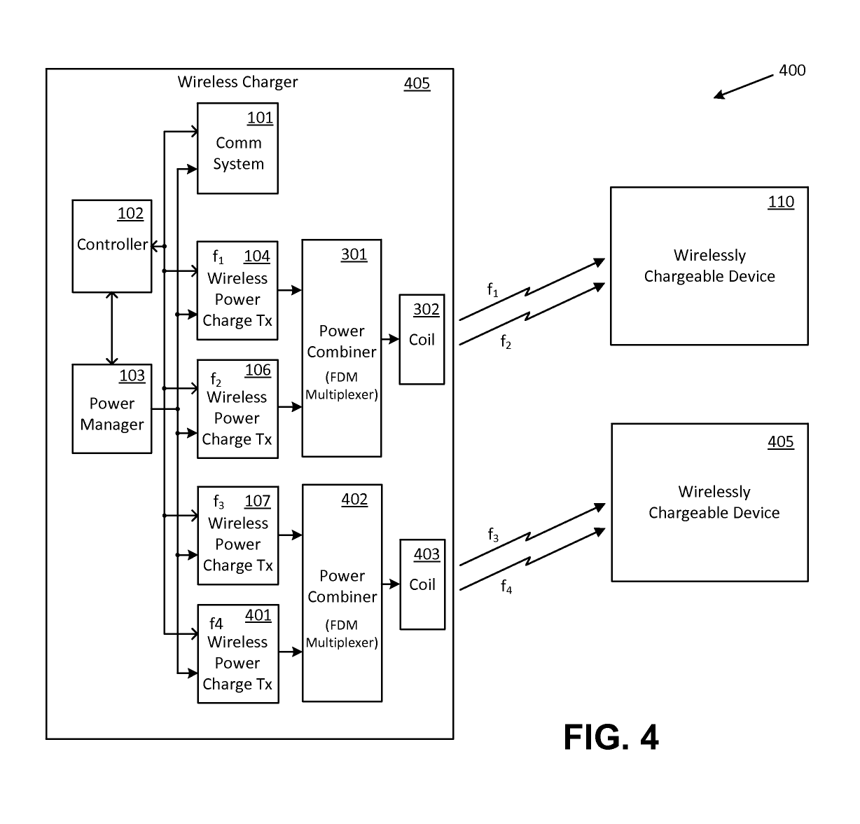

FIG. 4 shows a multi-frequency wireless power transfer system 400 that incorporates an FDM format for providing power to two wireless sly chargeable devices110 and 405 in accordance with invention.

In contrast to FIG. 3, which shows a multi-frequency wireless power transfer system 300 that uses a frequency division multiplexing (FDM) format for wirelessly transmitting an FDM charge by combining three frequencies f₁, f₂, and f₃, the embodiment shown in FIG. 4 shows a multi-frequency wireless power transfer system 400 that uses a frequency division multiplexing (FDM) format for wirelessly transmitting two FDM charges by pairing f₁ and f₂ into a first FDM charge and pairing f₃ and f₄ into a second FDM charge. Such a system may be referred to as a hybrid charging system because of the manner in which a FDM charge as well as a non-FDM charge are both transmitted by the same wireless charger.

In this particular exemplary embodiment, wireless charger 405 includes two power combiners 301 and 402 and two corresponding coils 302 and 403. In an alternative embodiment, wireless charger 405 may be configured as a non-hybrid system by transmitting a single FDM charge comprising two frequencies, by eliminating the other two frequencies and the corresponding circuitry.

Power combiner 301 accepts two power charges generated by wireless power charge transmitters 104 and 106, at frequencies f₁ and f₂, and multiplexes these charges into a first FDM power charge that is provided coil 302. Wirelessly chargeable device 110 uses this charge for charging a battery (not shown) contained in the device.

Similarly, power combiner 402 accepts two power charges generated by wireless power charge transmitters 107 and 401, at frequencies f₃ and f₄, and multiplexes these charges into a second FDM power charge that is provided coil 403. Wirelessly chargeable device 405 uses this charge for charging a battery (not shown) contained in the device.

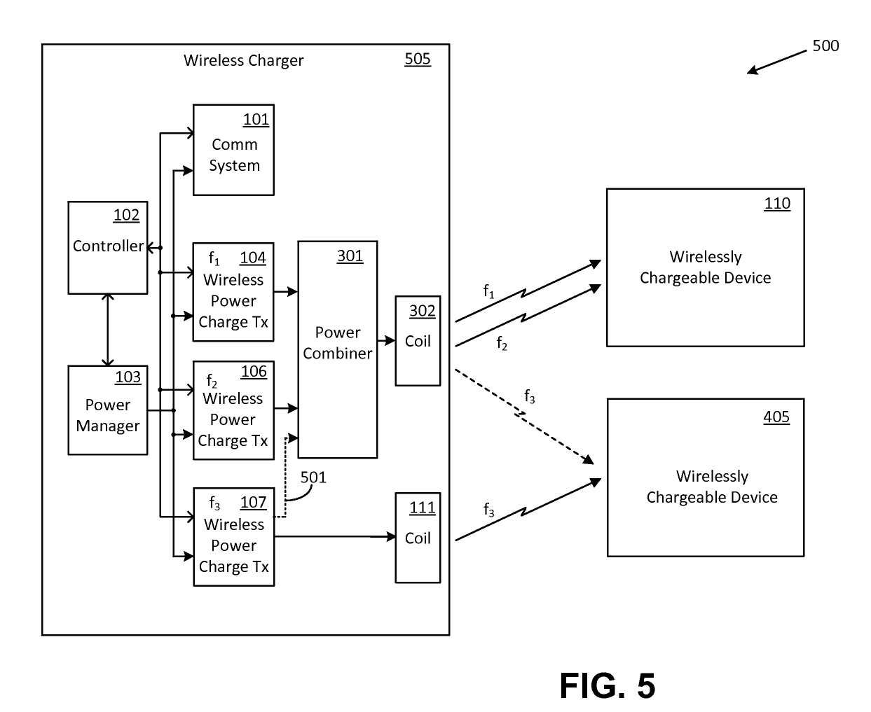

FIG. 5 shows a multi-frequency wireless power transfer system 500 that incorporates an FDM format for providing power to a first wireless sly chargeable device 110 and a FDM or a non-FDM format for providing power to a second wireless sly chargeable device 405, in accordance with invention.

Power combiner 301 accepts two power charges generated by wireless power charge transmitters 104 and 106, at frequencies f₁ and f₂, and multiplexes these charges into a first FDM power charge that is provided coil 302. Wirelessly chargeable device 110 uses this charge for charging a battery (not shown) contained in the device.

Wireless power charge transmitter 107 generates a third power charge at a frequency f₃ and provides this charge as a non-FDM charge to coil 111. Wirelessly chargeable device 405 uses this discrete charge for charging a battery (not shown) contained in the device.

In an alternative implementation, coil 111 may be eliminated, and the third power charge generated by wireless power charge transmitter 107 at frequency f₃ is provided to power combiner 301, which combines this third power charge with the other two power charges at the f1 and f₂ frequencies for generating a FDM charge comprising f₁, f₂ and f₃ power charges, that is provided to coil 302.

Wirelessly chargeable device 110 may use one or more of the three charges contained in the FDM charge, say a combination of the f₁ and f₂ charges, or a single charge f₁; while wireless sly chargeable device 110 may be configured to use any similar or different combination of charges (amongst the f₁, f₂ and f₃ charges), or a single charge, say, the f₃ power charge.

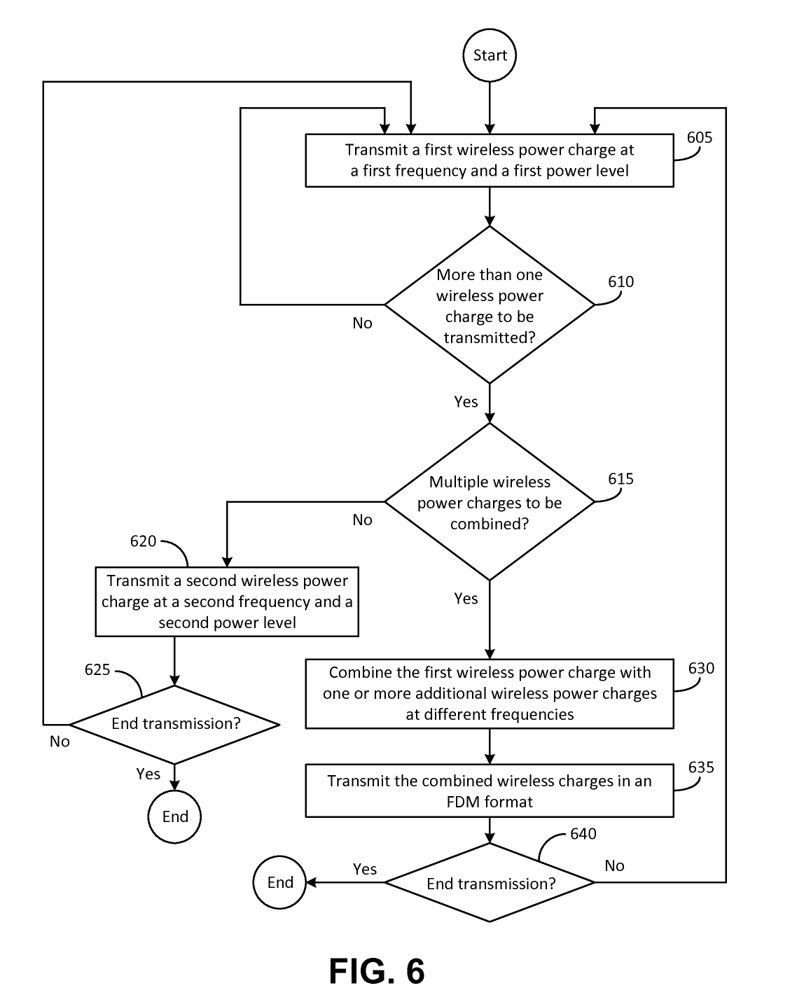

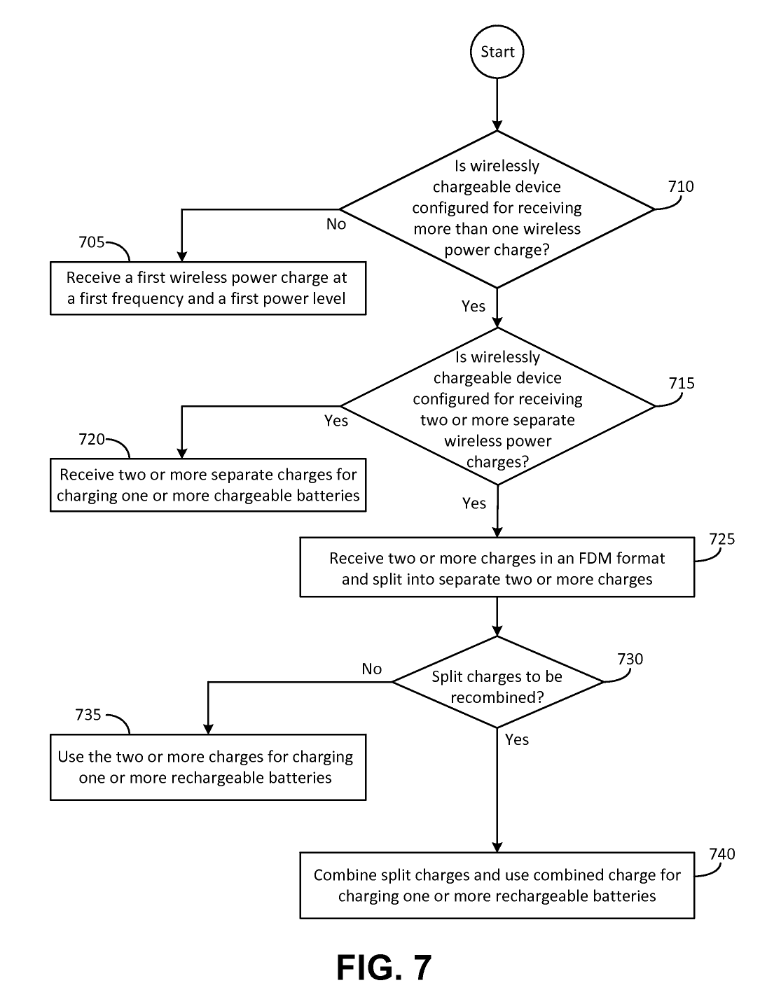

FIG. 6 shows a flowchart of a method of incorporating an FDM format for transmitting wireless power charges in accordance with the invention. It is to be understood that any method steps or blocks shown in FIG. 6 (as well as FIG. 7) may represent modules, segments, or portions of code that include one or more executable instructions for implementing specific logical functions or steps in the method. In certain implementations, one or more of the steps may be performed manually. It will be appreciated that, although particular example method steps are described below, additional steps or alternative steps may be utilized in various implementations without detracting from the spirit of the invention. Moreover, steps may be executed out of order from that shown or discussed, including substantially concurrently or in reverse order, depending on various alternative implementations. Code may be also contained in one or more devices, and may not be necessarily confined to any particular type of device. The explanation below, while possibly implying code residency and functionality in certain devices, does so solely for the purposes of explaining concepts behind the invention, and should not be construed in a limiting manner.

In block 605, a first wireless charge is transmitted at a first power level and at a first frequency. For example, drawing attention back to FIG. 1, wireless charger 105 transmits a first charge at a frequency f₁ out of coil 108 at a suitable amplitude. As described above, this initially transmitted amplitude may be subsequently changed, based, for example, on communications between master communication system 101 and a slave communication system, such as communication system 123 (if and when wirelessly chargeable device 110 is brought into proximity of wireless charger 105 with the intention of charging battery 128).

In block 610, a determination is made if more than one wireless power charge is to be transmitted. This determination may be carried out in various ways. In one exemplary embodiment, communications between master communication system 101 and a slave communication system, such as communication system 123 may be used for wireless charger 105 to identify the nature of the charging system (FDM or non-FDM) in wirelessly chargeable device 110.

In an alternative embodiment block 610 may be omitted and an FDM charge transmitted irrespective of the nature of the wirelessly chargeable device 110. When implemented in this manner, in a first embodiment, a human user of wirelessly chargeable device 110 may determine compatibility between wireless charger 105 and wireless sly chargeable device 110 (frequency, amplitude etc). In contrast, in a second embodiment, wireless sly chargeable device 110 may automatically use the first power charge transmitted by wireless charger 105 as a single charge.

If the determination in block 610 indicates that more than one wireless power is not needed, the first charge is wirelessly transmitted as a single charge.

However, if the determination in block 610 indicates that more than one wireless power is to be transmitted, another determination is made in block 615 to determine if the first charge is to be combined with additional charges. In other words, block 610 is used to determine if an FDM (for example, as shown in FIG. 3) or a non-FDM charge (for example, as shown in FIG. 2) is to be used.

If the determination in block 615 indicates that the first charge is not to be combined with additional charges, in block 620, a second wireless charge is transmitted at a second power level and at a second frequency f₂ (for example, as shown in FIG. 1). The second power level may be the same as the first power level, or may be different. Furthermore, the amplitude of the second power charge may be changed subsequently, as described above with reference to the first wireless power charge.

In block 625 a determination is made if transmission is to be ended. In certain embodiments, this may be carried out by detecting that a wireless sly chargeable device has been moved away, or is not located in proximity to wireless charger 105. If it is desired to continue transmission, action goes back to block 605 for recursive action. If not, the transmission of the two power charges is terminated.

If the determination in block 615 indicates that the first charge is to be combined with additional charges, in block 630, one or more additional wireless charges (for example, a second wireless charge at a second frequency f₂ and at a second power level, and additional charges, if so desired) are combined with the first charge to form an FDM wireless power charge (for example, as shown in FIG. 3).

In block 630, the FDM wireless power charge is transmitted. Block 640 resembles block 625 and performs a similar function.

FIG. 7 shows a flowchart of a method of receiving and using wireless power charges in accordance with the invention.

In block 710, a determination is made if a wirelessly chargeable device is configured for receiving more than one wireless power charge. If not so configured, in block 705, the wirelessly chargeable device may receive a single wireless power charge at a first power level and at a first frequency. For example, drawing attention back to FIG. 1, wirelessly chargeable device 110 may receive a wireless charge at a frequency f₁ via coil 121. (Coil 122, wireless power charge receiver 126 and power combiner 127 may be either eliminated in certain embodiments, or in certain other embodiments, these elements may be present but not used).

Upon receiving the wireless charge, the wirelessly chargeable device may determine that the amplitude of the received wireless charge is not at a desired level. If so, the wirelessly chargeable device communicates with the wireless charger and requests a change in wireless power charge level. Based on the response of the wireless charger, the power level may or not be changed.

In the determination in block 710 indicates that the wirelessly chargeable device is configured to receive multiple power charges, in block 715, a determination is made if the wireless sly chargeable device is configured to receive the multiple charges in an FDM format or a non-FDM format. If the determination indicates a non-FDM format, in block 720, wirelessly chargeable device receives two (or more) charges (for example, as shown in FIG. 1). The multiple power charges may be used to charge a single battery (for example, a high capacity battery located in a laptop) or may be used to charge multiple batteries (for example, a primary battery and a backup battery).

If the determination in block 715 indicates that the wirelessly chargeable device is configured to receive multiple power charges in an FDM format, in block 725 wirelessly chargeable device receives two (or more) charges in the FDM format and the individual charges are accessed by splitting the FDM power charge into constituent power charges. For example, as shown in FIG. 3, the FDM power charger is received via coil 304 and split into three charges by power splitter 303.

A determination is then made in block 730 if the multiple power charges are to be recombined for charging a single battery, or left alone in order to charge different batteries.

If desired to be recombined, in block 740, the split charges are recombined (for example, by using a power combiner 306 as shown in FIG. 3). On the other hand, if the split charges are not to be recombined, block 735 is executed and the split charges are left alone for use in charging multiple charges. This may be carried out, for example, by omitting power combiner 306 in FIG. 3, and using the three charges at f₁, f₂ and f₃ to charge three different batteries (not shown).

The person skilled in the art will appreciate that the description herein is directed at explaining multi-frequency wireless power transfer between a wireless charger and one or more wireless sly chargeable devices each containing a communication system that communicates with the wireless charger. Various frequencies are used for transferring multiple power charges. The multiple power charges may be provided as individual, independent charges, or may be combined in an FDM format.

While the systems and methods have been described by means of specific embodiments and applications thereof, it is understood that numerous modifications and variations could be made thereto by those skilled in the art without departing from the spirit and scope of the disclosure.

Accordingly, it is to be understood that the inventive concept is not to be limited by the specific illustrated embodiments, but only by the scope of the appended claims. The description may provide examples of similar features as are recited in the claims, but it should not be assumed that such similar features are identical to those in the claims unless such identity is essential to comprehend the scope of the claim. In some instances the intended distinction between claim features and description features is underscored by using slightly different terminology.

What is claimed is:

1. A system, comprising:
a wireless charger, comprising:
a power management system;
a first wireless power charge transmitter for providing a first wireless power charge for charging a first chargeable battery, the first wireless power charge transmitter operative to generate the first wireless power charge at a first frequency and at a first power level, the first power level defined by the power management system; and
a second wireless power charge transmitter for providing a second wireless power charge for charging a second chargeable battery, the second wireless power charge transmitter operative to generate the second wireless power charge at a second frequency and at a second power level, the second power level defined by the power management system.

2. The system of claim 1, further comprising:
a first coil that receives the first wireless power charge and radiates the first wireless power charge for wirelessly charging the first chargeable battery; and
a second coil that receives the second wireless power charge and radiates the second wireless power charge for wirelessly charging the second chargeable battery.

3. The system of claim 1, further comprising a first power combiner that combines the first wireless power charge and the second wireless power charge and generates therefrom, a first frequency division multiplexed (FDM) wireless power charge.

4. The system of claim 3, further comprising:
a first coil that receives the first FDM wireless power charge and radiates the first FDM wireless power charge for wirelessly charging the first and the second chargeable batteries.

5. The system of claim 4, further comprising:
a third wireless power charge transmitter for providing a third wireless power charge for charging a third chargeable battery, the third wireless power charge transmitter operative to generate the third wireless power charge at a third frequency and at a third power level, the third power level defined by the power management system; and
a second coil that receives the third wireless power charge and radiates the third wireless power charge for wireless sly charging the third chargeable battery.

6. The system of claim 4, further comprising:
a third wireless power charge transmitter for providing a third wireless power charge for charging a third chargeable battery, the third wireless power charge transmitter operative to generate the third wireless power charge at a third frequency and at a third power level, the third power level defined by the power management system;
a fourth wireless power charge transmitter for providing a fourth wireless power charge for charging a fourth chargeable battery, the fourth wireless power charge transmitter operative to generate the fourth wireless power charge at a fourth frequency and at a fourth power level, the fourth power level defined by the power management system;
a second power combiner that combines the third wireless power charge and the fourth wireless power charge and generates therefrom, a second frequency division multiplexed (FDM) wireless power charge; and
a second coil that receives the second FDM wireless power charge and radiates the second FDM wireless power charge for wireless sly charging the third and the fourth chargeable batteries.

7. The system of claim 6, wherein at least one of the first, second, third or fourth chargeable batteries is the same as another one of the first, second, third or fourth chargeable batteries.

8. The system of claim 3, further comprising:
a wirelessly chargeable device, comprising:
a first wireless power charge receiver for receiving the first wireless power charge transmitted by the first wireless power charge transmitter and coupling the received first wireless power charge to the first chargeable battery; and
a second wireless power charge receiver for receiving the second wireless power charge transmitted by the second wireless power charge transmitter and coupling the second wireless power charge to the second chargeable battery.

9. A system, comprising:
a wirelessly chargeable device, comprising:
a first wireless power charge receiver for receiving a first wireless power charge at a first frequency, and for coupling the first wireless power charge to a first chargeable battery; and
a second wireless power charge receiver for receiving the second wireless power charge at a second frequency, and for coupling the second wireless power charge to a second chargeable battery.

10. The system of claim 9, further comprising:
a first coil for receiving the first wireless power charge at the first frequency and providing the received first wireless power charge to the first wireless power charge receiver; and
a second coil for receiving the second wireless power charge at the second frequency and providing the received second wireless power charge to the second wireless power charge receiver.

11. The system of claim 10, wherein the first chargeable battery is the same as the second chargeable battery.

12. The system of claim 9, further comprising:
a wireless charger, comprising:
a first power combiner for combining the first wireless power charge and the second wireless power charge and generating therefrom, a frequency division multiplexed (FDM) wireless power charge.

13. The system of claim 12, further comprising:
a coil for receiving the first FDM wireless power charge and providing the FDM wireless power charge to at least one of the first or the second wireless power charge receivers.

14. The system of claim 12, further comprising:
a coil for receiving the first FDM wireless power charge and providing a first portion of the FDM wireless power charge to the first wireless power charge receiver and a second portion of the FDM wireless power charge to the second wireless power charge receiver.

15. The system of claim 14, wherein the first wireless power charge receiver is configured to extract the first wireless power charge at the first frequency from the first portion of the FDM wireless power charge, and the second wireless power charge receiver is configured to extract the second wireless power charge at the second frequency from the second portion of the FDM wireless power charge.

16. A method comprising:
transmitting a first wireless power charge at a first frequency;
receiving the first wireless power charge in a first wireless power charge receiver;
using the received first wireless power charge to charge a first chargeable battery in the first wireless power charge receiver;
transmitting a second wireless power charge at a second frequency;
receiving the second wireless power charge in a second wireless power charge receiver; and
using the received second wireless power charge to charge a second chargeable battery in the second wireless power charge receiver.

17. The method of claim 16, wherein the first and second wireless power charges are transmitted concurrently in a frequency division multiplexed (FDM) format.

18. The method of claim 17, wherein a power splitter is used for splitting the first and second wireless power charges from the FDM format, and a) used separately for charging a first chargeable battery and a second chargeable battery respectively, or b) recombined using a power combiner for using the first and second wireless power charges combinedly to charge a single chargeable battery.

19. The method of claim 17, wherein the first and the second wireless power charge receivers are co-located in a device, and wherein the first chargeable battery is the same as the second chargeable battery.

20. The method of claim 17, further comprising:
transmitting a third wireless power charge at a third frequency; and
receiving the third wireless power charge in a third wireless power charge receiver, wherein the first and the second wireless power charge receivers are co-located in a first device, and the third wireless power charge receiver is located in a second device.
